(19) United States
(12) Patent Application Publication
(10) Pub. No.: US 2022/0005085 A1
(43) Pub. Date: Jan. 6, 2022

(54) INFORMATION PROCESSING APPARATUS AND NON-TRANSITORY COMPUTER READABLE MEDIUM

(71) Applicant: FUJIFILM BUSINESS INNOVATION CORP., Tokyo (JP)

(72) Inventors: Ryo SHIMURA, Kanagawa (JP); Shotaro MISAWA, Kanagawa (JP); Masahiro SATO, Kanagawa (JP); Tomoki TANIGUCHI, Kanagawa (JP); Tomoko OHKUMA, Kanagawa (JP)

(73) Assignee: FUJIFILM BUSINESS INNOVATION CORP., Tokyo (JP)

(21) Appl. No.: 17/154,614

(22) Filed: Jan. 21, 2021

(30) Foreign Application Priority Data
Jul. 2, 2020 (JP) 2020-115080

(51) Int. Cl. G06Q 30/02; G06F 16/9536; G06N 20/00

(52) U.S. Cl. CPC G06Q 30/0282; G06N 20/00; G06F 16/9536

(57) ABSTRACT

An information processing apparatus includes: a processor configured to: receive a text for a target that is input from a user; specify past texts similar to the received text based on similarity degrees between the received text and past texts that are in the past at a time when the text for the target is posted; and predict a user's rating for the target based on ratings associated with the specified past texts.

### CROSS-REFERENCE TO RELATED APPLICATIONS

This application is based on and claims priority under 35 USC 119 from Japanese Patent Application No. 2020-115080 filed Jul. 2, 2020.

### BACKGROUND

### (i) Technical Field

The present disclosure relates to an information processing apparatus and a non-transitory computer readable medium.

### (ii) Related Art

For example, JP-A-2017-027480 describes an item recommendation system that is less affected by a result of an attack, even when an attack made by introducing a fake user is received. The item recommendation system includes a rating matrix storage unit that stores a rating matrix for entering ratings related to a user's item, and a first similarity calculation unit that calculates a similarity between users by using a similarity scale that suppresses the appearance of hubs. In addition, the item recommendation system includes a first neighborhood data extraction unit that extracts k users from the one with the highest similarity with a target user by using the similarity calculated by the first similarity calculation unit, and a first rating prediction unit that predicts the ratings to be entered in the blank cells according to the target users by using the ratings related to the items of k users extracted by the first neighborhood data extraction unit. Further, the item recommendation system includes an item recommendation unit that extracts items to be recommended to the target user from items with a high rating predicted by the first rating prediction unit and recommends them to the target user.

JP-A-2019-049980 describes a method of providing a recommendation to a user. This method obtains the stored data structure triplets and the actual evaluations associated with the data structure triplets, and trains a machine learning model using the stored data structure triplets and the associated actual evaluations. Training a machine learning model involves generating user, product, and review representations based on the stored data structure triplets and the associated actual evaluations. The method also includes predicting an evaluation using the user, product, and review representations from which the machine learning model is generated, and making recommendations based on the predicted evaluation.

JP-A-2013-246503 describes a product recommendation method executed by a computer. In the product recommendation method, a rating prediction unit refers to the similarity between products stored in the similarity database stored in a storage unit to calculate a predicted rating that predicts the rating of the user's unevaluated product and a variance of the predicted rating with respect to the true rating by using the rating of the product that has been evaluated by the user among the products similar to the unevaluated product that the user has not yet evaluated for each user. Further, in the product recommendation method, the rating prediction unit stores the calculated predicted rating and the variance for each user in the prediction information database of the storage unit in association with the product name of the unevaluated product. In the product recommendation method, a recommended product determination unit calculates the purchase probability of unevaluated products from the purchase probability of the evaluated product of the logged-in user, the predicted rating associated with the product name of the unevaluated product, and the variance of the predicted rating, which are stored in the prediction information database of the storage unit. Further, in the product recommendation method, the recommended product determination unit displays the product name on the user terminal of the logged-in user in descending order of the calculated purchase probability of the unevaluated products.

### SUMMARY

For example, there is a system in which plural users input reviews and ratings for a certain product and the reviews and ratings are published to other users. In such a system, the users are influenced by the ratings of the past reviews to determine ratings to be input. Thus, ratings for the product may be predicted in consideration of the influence of the past reviews. In this case, the influence is predicted using a weighted average of the past reviews that is calculated using the posting date and time of the past reviews as weighting values, and, as the posting date and time is later, the influence becomes stronger.

However, when the weighted average calculated using the posting date and time as weighting values is used, the rating is predicted premised on that the user is more strongly influenced when a past review has a later posting date and time, regardless of the content of the review. In this case, since the content of the review is not considered, the influence is predicted using reviews even having the content different from that of the user's review, and it may be difficult to accurately predict a user's subjective rating.

Aspects of non-limiting embodiments of the present disclosure relate to an information processing apparatus and a non-transitory computer readable medium capable of accurately predicting a user's subjective rating for a target, as compared with a case where an influence of past texts for the target is predicted using the posting date and time of the past texts.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus including: a processor configured to: receive a text for a target that is input from a user; specify past texts similar to the received text based on similarity degrees between the received text and past texts that are in the past at a time when the text for the target is posted; and predict a user's rating for the target based on ratings associated with the specified past texts.

### BRIEF DESCRIPTION OF THE DRAWINGS

Exemplary embodiment(s) of the present disclosure will be described in detail based on the following figures, wherein:

FIG. 1 is a block diagram illustrating an example of an electrical configuration of an information processing apparatus according to a first exemplary embodiment;

FIG. 2 is a diagram illustrating a customer review system according to a comparative example;

FIG. 3 is a diagram illustrating a latent factor model according to the comparative example;

FIG. 4A is a diagram illustrating a rating prediction method according to the comparative example;

FIG. 4B is a diagram illustrating a rating prediction method according to an exemplary embodiment;

FIG. 5 is a block diagram illustrating an example of a functional configuration of an information processing apparatus according to a first exemplary embodiment;

FIG. 6 is a flowchart illustrating an example of a rating learning process by an information processing program according to the first exemplary embodiment;

FIG. 7 is a diagram illustrating the rating learning process according to the first exemplary embodiment;

FIG. 8 is a flowchart illustrating an example of a rating prediction process by the information processing program according to the first exemplary embodiment;

FIG. 9 is a diagram illustrating the rating prediction process according to the first exemplary embodiment;

FIG. 10 is a block diagram illustrating an example of a functional configuration of an information processing apparatus according to a second exemplary embodiment;

FIG. 11 is a diagram illustrating a correlation between the content of a review text and a rating according to the second exemplary embodiment;

FIG. 12 is a flowchart illustrating an example of a rating learning process by an information processing program according to the second exemplary embodiment;

FIG. 13 is a diagram illustrating the rating learning process according to the second exemplary embodiment;

FIG. 14 is a flowchart illustrating an example of a rating prediction process by the information processing program according to the second exemplary embodiment; and

FIG. 15 is a diagram illustrating the rating prediction process according to the second exemplary embodiment.

### DETAILED DESCRIPTION

Hereinafter, exemplary embodiments will be described in detail with reference to the accompanying drawings.

### First Exemplary Embodiment

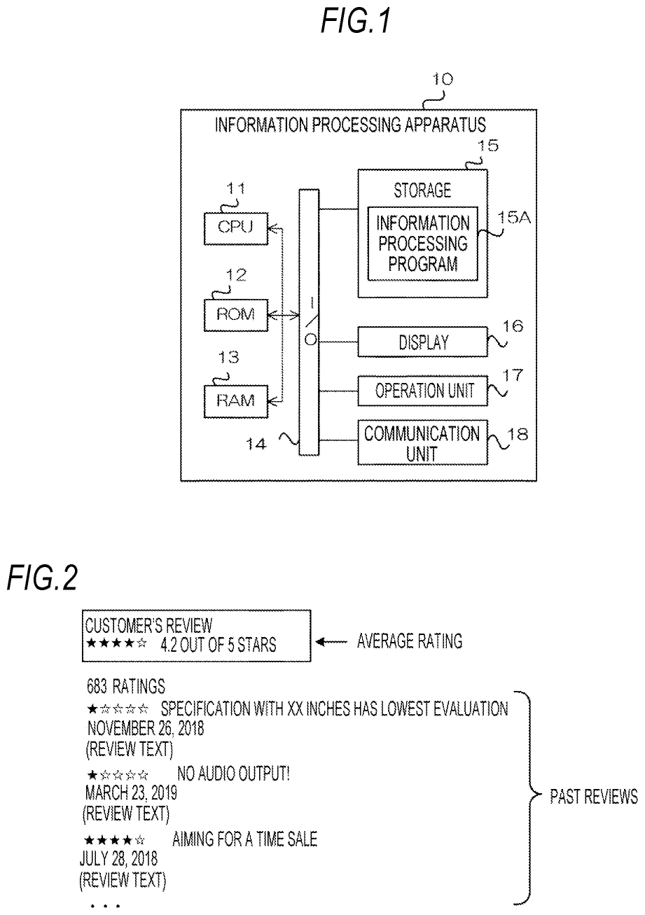

FIG. 1 is a block diagram illustrating an example of an electrical configuration of an information processing apparatus 10 according to a first exemplary embodiment.

As illustrated in FIG. 1, the information processing apparatus 10 according to the present exemplary embodiment includes a central processing unit (CPU) 11, a read only memory (ROM) 12, a random access memory (RAM) 13, an input/output interface (I/O) 14, a storage 15, a display 16, an operation unit 17, and a communication unit 18.

A general-purpose computer device such as a server computer or a personal computer (PC) is applied to the information processing apparatus 10 according to the present exemplary embodiment.

The CPU 11, the ROM 12, the RAM 13, and the I/O 14 are connected to each other via a bus. Functional units including the storage 15, the display 16, the operation unit 17, and the communication unit 18 are connected to the I/O 14. Each of these functional units may communicate with the CPU 11 via the I/O 14.

A controller includes the CPU 11, the ROM 12, the RAM 13, and the I/O 14. The controller may be configured as a sub controller that controls a part of the operation of the information processing apparatus 10, or may be configured as a part of a main controller that controls the entire operation of the information processing apparatus 10. For example, an integrated circuit such as a large scale integration (LSI) or an integrated circuit (IC) chipset is used for a part or entirety of each block of the controller. An individual circuit may be used for each of the blocks, or a circuit in which a part or all of the blocks are integrated may be used. The blocks may be provided integrally, or certain blocks may be provided separately. In each of the blocks, a part of the block may be provided separately. The integration of the controller is not limited to the LSI, and a dedicated circuit or a general-purpose processor may be used.

Examples of the storage 15 include a hard disk drive (HDD), a solid state drive (SSD), and a flash memory. An information processing program 15A according to the present exemplary embodiment is stored in the storage 15. The information processing program 15A may be stored in the ROM 12.

The information processing program 15A may be installed in, for example, the information processing apparatus 10 in advance. The information processing program 15A may be implemented by storing the information processing program 15A in a non-volatile storage medium or distributing the information processing program 15A via a network and appropriately installing the information processing program 15A in the information processing apparatus 10. Examples of the non-volatile storage medium include a compact disc read only memory (CD-ROM), a magneto-optical disc, an HDD, a digital versatile disc only memory (DVD-ROM), a flash memory, and a memory card.

Examples of the display 16 include a liquid crystal display (LCD) and an organic electro luminescence (EL) display. The display 16 may integrally have a touch panel. The operation unit 17 is provided with a device for operation input such as a keyboard or a mouse. The display 16 and the operation unit 17 receive various instructions from a user of the information processing apparatus 10. The display 16 displays various information such as a result of a process executed in response to an instruction received from the user and a notification about the process.

The communication unit 18 is connected to a network such as the Internet, a local area network (LAN), or a wide area network (WAN), and enables communication with an image forming apparatus and other external devices such as a PC via the network.

In the present exemplary embodiment, the term “text” refers to a text representing an evaluation given by the user to a “target”. Examples of the “text” include customer reviews (hereinafter, which may be simply referred to as “reviews”) and comments. In the present exemplary embodiment, a case in which reviews are employed as an example of the “texts” will be described. The term “target” refers to an object to which the user gives an evaluation and includes tangible objects and intangible objects. Examples of the “target” include items and blogs which will be described later. The term “rating” refers to a value representing an evaluation given by the user to the “target”.

Here, an outline of the customer review system according to a comparative example will be described with reference to FIG. 2.

FIG. 2 is a diagram illustrating the customer review system according to the comparative example.

As illustrated in FIG. 2, the customer review system is a system use in an electronic commerce (EC) site. With the system, it is possible to share purchasers' evaluations for a product with other users. The EC site is a site that sells products, services, and the like of a company running the EC site (hereinafter, these products, services, and the like may also referred to as “items”) on a website independently operated on the Internet. The term “user” refers to a user of the EC site, and the term “purchaser” refers to a user who purchases an item.

In the customer review system, it is possible to post and share purchasers' reviews, and for users to view the reviews posted by the purchasers. Information contained in this review includes, for example, a rating, a review text, and a posting date and time. The item rating is an example of the evaluation value. The rating refers to a value that is given by a purchaser to an item on a multi grade evaluation system (for example, on a scale of 1 to 5). For example, the rating “5” indicates the highest evaluation. The review text refers to a text freely filled in by the purchaser. The posting date and time refers to a date and time when the review text is posted. This system also has a recommendation algorithm, and recommends an item to a user based on information in the obtained reviews.

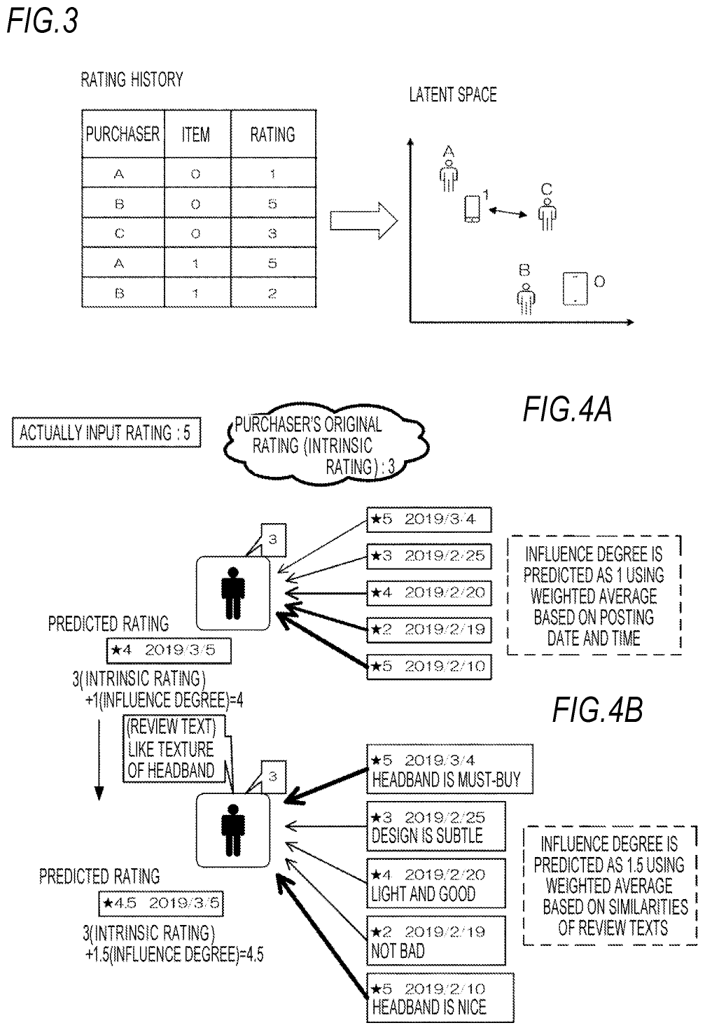

Next, a latent factor (LF) model that is widely used as a rating prediction method will be specifically described with reference to FIG. 3.

FIG. 3 is a diagram illustrating the latent factor model according to the comparative example.

When the latent factor model is trained, as illustrated in FIG. 3, a “user's preference” and the “contents of an item” are expressed in the same latent space based on a history of ratings given to items by purchasers. When a rating is predicted using the latent factor model, the rating is predicted by calculating a distance between the “user's preference” and the “contents of the item” in the latent space. In the example of FIG. 3, a distance of the arrow connecting a “purchaser C” and an “item 1” is the rating. The distance mentioned herein is expressed as an inner product of vectors.

As illustrated in FIG. 3, ratings are predicted using the latent factor model, and an item having a high predicted rating is recommended to the user.

That is, the ratings are used for training the latent factor model and are used for supporting users to make decisions. The ratings are premised on that the purchasers give ratings that the purchasers feel, that is, purchasers' original ratings. However, it is known that there is actually a correlation between the “rating” and an “average of ratings that are posted up to that time”. For example, it is assumed that the purchaser's original rating has is “3”. Even in this case, if the average rating is “4”, the actual rating tends to be predicted to a value close to “4”. For this reason, influence of past reviews may be considered.

FIG. 4A is a diagram illustrating a rating prediction method according to the comparative example. FIG. 4B is a diagram illustrating a rating prediction method according to the present exemplary embodiment.

As illustrated in FIG. 4A, influence may be predicted using a weighted average of past reviews that are calculated using the posting date and time as weighting values. In this case, a past review having a later posting date and time is has stronger influence.

However, in the example illustrated in FIG. 4A in which the weighted average calculated using the posting date and time as the weighting values is used, a rating is predicted on the assumption that a past review having a later posting date and time has strong influence irrespective of the content of the past review. In this case, since the content of the review is not considered, the influence is predicted using reviews even having the content different from that of the user's review, and it may be difficult to accurately predict a user's subjective rating.

Therefore, in the present exemplary embodiment, as illustrated in FIG. 4B, the rating is predicted in consideration of the content of the past reviews. As a result, the rating is predicted with higher accuracy than the comparative example of FIG. 4A.

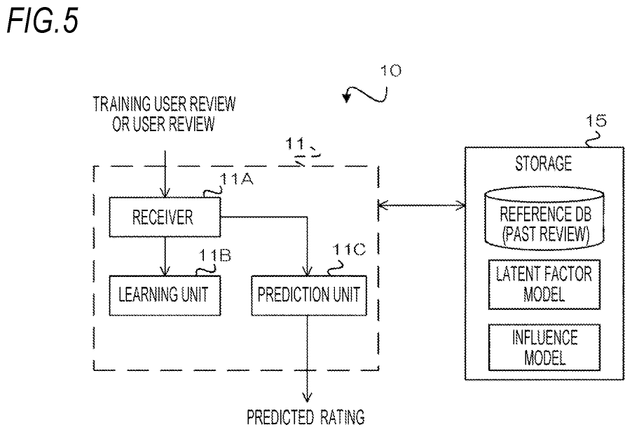

The CPU 11 of the information processing apparatus 10 according to the present exemplary embodiment serves as respective units illustrated in FIG. 5 by writing the information processing program 15A stored in the storage 15 into the RAM 13 and executing the information processing program 15A. The CPU 11 is an example of a processor.

FIG. 5 is a block diagram illustrating an example of the functional configuration of the information processing apparatus 10 according to the first exemplary embodiment.

As illustrated in FIG. 5, the CPU 11 of the information processing apparatus 10 according to the present exemplary embodiment serves as a receiver 11A, a learning unit 11B, and a prediction unit 11C. In the present exemplary embodiment, the learning unit 11B and the prediction unit 11C are implemented by a single device. Alternatively, the learning unit 11B and the prediction unit 11C may be implemented by separate devices. That is, plural information processing apparatuses 10 may be provided. The plural information processing apparatuses 10 may include (i) an information processing apparatus 10 for learning (training) that includes a CPU 11 serving as the receiver 11A and the learning unit 11B, and (ii) an information processing apparatus 10 for prediction that includes a CPU 11 serving as the receiver 11A and the prediction unit 11C.

The storage 15 according to the present exemplary embodiment stores a reference database (hereinafter, referred to as a “reference DB”), a latent factor model, and an influence model. The reference DB may be stored in an external storage device instead of the storage 15.

The reference DB stores a set of reviews posted in the past (hereinafter, referred to as a “set of reference reviews”). The set of reference reviews includes, for each review, a purchaser identification (ID), a product ID, a rating, and a review text. As illustrated in FIG. 3 above, the latent factor model is a model in which the “user's preference” and the “content of the item” are expressed in the same latent space based on the history of ratings given to the items by the purchasers. The influence model is a model used to predict an influence degree that indicates a degree of influence received from past reviews. Both the latent factor model and the influence model are mathematical models obtained by machine learning. A model used for machine learning is not particularly limited, but as an example, various models such as a neural network are applied. The term “item” referred to herein represent a target of a review. The items include the above-mentioned products and services, as well as blogs and the like provided on a social networking service (SNS). The item may be tangible or intangible.

When the latent factor model and the influence model are trained, the receiver 11A according to the present exemplary embodiment receives input of training user reviews. The training user reviews are a set of reviews posted in the past. Each training user review includes a purchaser ID, a product ID, and a review text. The training user reviews are sorted in advance by date of the posting date and time. Labeled training data of the rating is associated with the training user review in advance.

The learning unit 11B according to the present exemplary embodiment trains the latent factor model and the influence model using the training user reviews and the reference DB. The learning process (training process) by the learning unit 11B is referred to as a “rating learning process”.

Meanwhile, when the rating is predicted using the latent factor model and the influence model trained by the learning unit 11B, the receiver 11A according to the present exemplary embodiment receives an input of a user reviews that is a review for an item from the user. Similar to the training user reviews, the user review includes a purchaser ID, a product ID, and a review text for each review.

The prediction unit 11C according to the present exemplary embodiment uses the reference DB to calculate similarity degrees between the received user review and the past reviews for the item that are in the past at the time when the received user review is posted. Then, the prediction unit 11C specifies past reviews similar to the user review based on the calculated similarity degrees, and predicts a user's rating for the item based on the ratings associated with the specified past reviews. The prediction process by the prediction unit 11C is referred to as a “rating prediction process”.

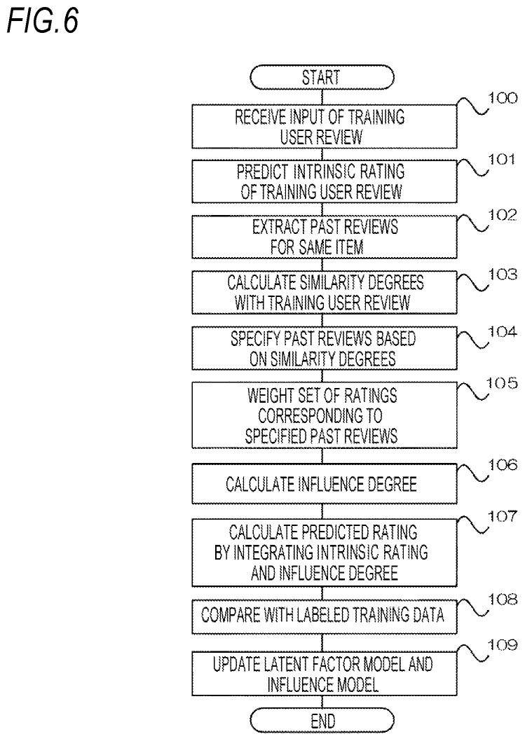

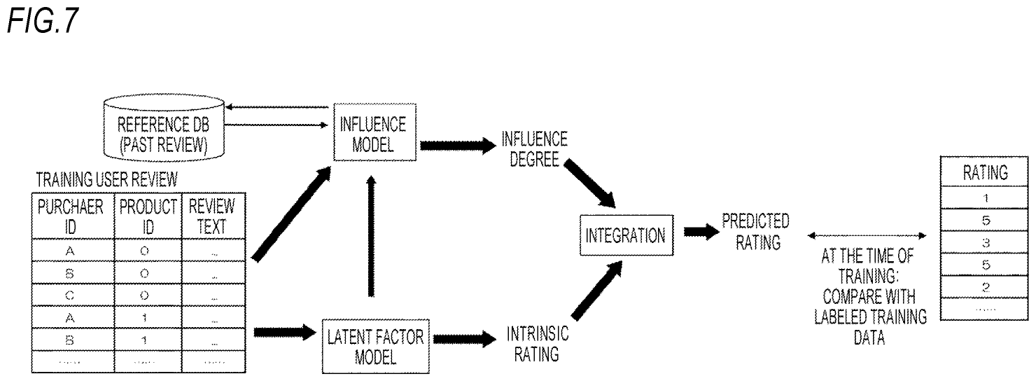

Next, the rating learning process according to the first exemplary embodiment will be specifically described with reference to FIGS. 6 and 7.

FIG. 6 is a flowchart illustrating an example of the rating learning process by the information processing program 15A according to the first exemplary embodiment. FIG. 7 is a diagram illustrating the rating learning process according to the first exemplary embodiment.

First, when the information processing apparatus 10 is instructed to execute the rating learning process, the information processing program 15A is started by the CPU 11 to execute each of the following steps.

In step 100 of FIG. 6, the CPU 11 receives the input of the training user reviews, for example, illustrated in FIG. 7. As described above, the training user reviews are a set of reviews posted in the past. Each training user review includes a purchaser ID, a product ID, and a review text.

In step 101, the CPU 11 predicts intrinsic ratings, which are potential ratings, by using, for example, the latent factor model illustrated in FIG. 7 for the training user reviews received in step 100. The phrase “predict an intrinsic rating” refers to “predict a user's original rating”. As illustrated in FIG. 3, the intrinsic rating is predicted by calculating an inner product of the item representation representing the item and the user representation representing the user that are projected on the same latent space. For the solution of the latent factor model, for example, matrix factorization, biased matrix factorization, or the like may be used. Specifically, the intrinsic rating r_{LF} is calculated by the following equation (1).

r_{LF}=pᵤ·qᵢ+μᵤμᵢ+μ (1)

The symbol “pᵤ” indicates a latent space vector of the user, the symbol “qᵢ” indicates a latent space vector of the item, and the symbol “·” indicates an inner product. The symbols “uᵤ”, “uᵢ”, and “u” represent learning parameters indicating a user bias, an item bias, and an overall average of ratings, respectively.

Next, in step 102, the CPU 11 searches, for example, the reference DB illustrated in FIG. 7 based on the training user reviews received in step 100, and extracts past reviews for the same item from the reference DB. The past reviews are reviews that are in the past at the posting date and time of the training user reviews. The past reviews include a set of review texts and a set of ratings, for each same item.

In step 103, the CPU 11 calculates similarity degrees between the training user reviews and each of the past reviews extracted in step 102. For the calculation of the similarity degrees, for example, known methods such as the Latent Dirichlet Allocation (LDA) or the Term Frequency-Inverse Document Frequency (TF-IDF) may be used.

In step 104, the CPU 11 specifies past reviews based on the similarity degrees calculated in step 103. The specified past reviews may be a predetermined part of the past reviews that are arranged in descending order of the similarity degrees, or may be all past reviews for which the similarity degrees are calculated.

In step 105, the CPU 11 uses, for example, the influence model illustrated in FIG. 7 to calculate a weighted average value of a set of ratings corresponding to the past reviews specified in step 104 using the similarity degrees as weighting values. The set of ratings is represented, for example, as a set containing a predetermined number of ratings ranked by the similarity degrees.

The weighting of the ratings may be performed using an order in which the past reviews are actually displayed on a predetermined EC site (see, for example, FIG. 2) in addition to the similarity degrees. The weighting of the ratings may be performed using a statistic including at least one of a variance, a median value, or a mode value of the ratings that are obtained from the set of ratings.

In step 106, the CPU 11 calculates influence degrees indicating degrees of influence received from the past reviews. This influence degree is expressed as a difference between the weighted average value calculated in step 105 and the intrinsic rating predicted in step 101. Specifically, the influence degree r_{EK} is expressed by the following equation (2) using the weighted average value r_{infl} and the intrinsic rating r_{LF}.

r_{EK}=r_{infl}−r_{LF} (2)

In step 107, for example, as illustrated in FIG. 7, the CPU 11 calculates predicted ratings by integrating the intrinsic ratings predicted in step 101 and the influence degrees calculated in step 106. Specifically, the predicted rating \hat{r} is calculated by the following equation (3).

\hat{r}=r_{LF}+αᵤ(r_{infl}−r_{LF}) (3)

Here, the symbol “r_{LF}” indicates the intrinsic rating, the symbol “αᵤ” indicates a coefficient uniquely learned (trained) for each user, and the symbol “r_{infl}” indicates the weighted average value. It is apparent from the above equation (2), the symbol “(r_{infl}−r_{LF})” represents the influence degree r_{EK}. That is, the influence degree r_{EK} and the intrinsic rating r_{LF} are integrated by adding the intrinsic rating r_{LF} to a product of the coefficient αᵤ and the influence degree r_{EK}.

In step 108, the CPU 11 compares the predicted ratings calculated in step 107 with the labeled training data of the ratings associated with the training user reviews, for example, as illustrated in FIG. 7.

In step 109, the CPU 11 updates the latent factor model and the influence model based on the comparison result in step 108 such that the prediction result of the rating approaches the labeled training data, and ends the rating learning process by the information processing program 15A.

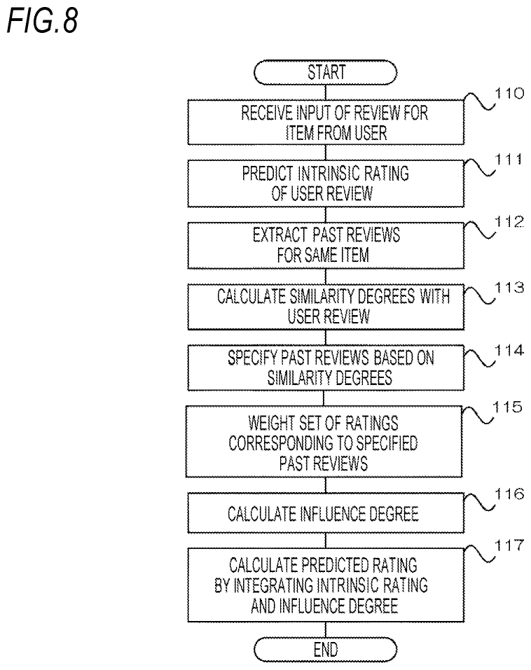

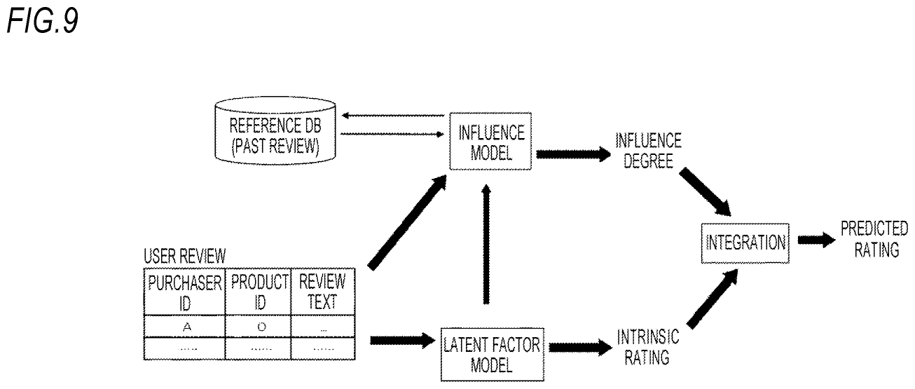

Next, the rating prediction process according to the first exemplary embodiment will be specifically described with reference to FIGS. 8 and 9. In this rating prediction process, the latent factor model and the influence model trained in the rating learning process are used.

FIG. 8 is a flowchart illustrating an example of the rating prediction process by the information processing program 15A according to the first exemplary embodiment. FIG. 9 is a diagram illustrating the rating prediction process according to the first exemplary embodiment.

First, when the information processing apparatus 10 is instructed to execute the rating prediction process, the information processing program 15A is started by the CPU 11 to execute each of the following steps.

In step 110 of FIG. 8, the CPU 11 receives an input of a review for an item from a user (hereinafter, referred to as a “user review”), for example, as illustrated in FIG. 9. This user review includes a purchaser ID, a product ID, and a review text for each review.

In step 111, the CPU 11 predicts the intrinsic rating, which is a potential rating, by using, for example, the latent factor model illustrated in FIG. 9 for the user review received in step 110. Specifically, the intrinsic rating is calculated by the above equation (1).

In step 112, the CPU 11 searches, for example, the reference DB illustrated in FIG. 9 based on the user review received in step 110, and extracts past reviews for the same item from the reference DB. The past reviews include reviews that are in the past at the posting date and time of the user review. The past reviews include a set of review texts and a set of ratings, for each same item.

In step 113, the CPU 11 calculates similarity degrees between the user review and each of the past reviews extracted in step 112. For the calculation of the similarity degrees, known methods such as, for example, the LDA or the TF-IDF may be used.

In step 114, the CPU 11 specifies past reviews based on the similarity degrees calculated in step 113. The specified past reviews may be a predetermined part of the past reviews that are arranged in descending order of the similarity degrees, or may be all past reviews for which the similarity degrees are calculated.

In step 115, the CPU 11 uses, for example, the influence model illustrated in FIG. 9 to calculate a weighted average value of the set of ratings corresponding to the past reviews specified in step 114 using the similarity degrees as the weighting values. As described above, the set of ratings is represented as a set containing a predetermined number of ratings ranked by the similarity degrees.

As described above, the weighting of the ratings may be performed using an order in which the past reviews are actually displayed on a predetermined EC site (see, for example, FIG. 2) in addition to the similarity degrees. The weighting of the ratings may be performed using a statistic including at least one of a variance, a median value, or a mode value of the ratings that are obtained from the set of ratings.

In step 116, the CPU 11 calculates an influence degree indicating a degree of influence received from the past reviews. This influence degree is expressed as a difference between the weighted average value calculated in step 115 and the intrinsic rating predicted in step 111. Specifically, the influence degree is expressed by the above equation (2).

In step 117, for example, as illustrated in FIG. 9, the CPU 11 integrates the intrinsic rating predicted in step 111 and the influence degree calculated in step 116 to calculate a predicted rating, and ends the rating prediction process by the information processing program 15A. Specifically, the predicted rating is calculated by the above equation (3).

As described above, according to the present exemplary embodiment, the influence of the past reviews for the item is reflected. Therefore, the user's subjective rating for the item is predicted with high accuracy.

Here, the CPU 11 may perform control so as to present the rating, which is predicted based on the past reviews, to the user when the user is to input a rating associated with the review that the user inputs for the item. When a rating that is input in association with the review that the user inputs for the item is different from the rating, which is predicted based on the past reviews, the CPU 11 may perform control so as to present to the user a fact that the input rating is different from the predicted rating.

Meanwhile, when the rating that the user is to give and the predicted user's original rating (that is, the intrinsic rating) deviate from each other, the rating predicted by the rating prediction process according to the present exemplary embodiment may be presented. Whether the two ratings deviate from each other is determined based on, for example, whether a difference between the two ratings is equal to or greater than a threshold value.

The CPU 11 may perform control so as to extract the past texts whose influence degrees are equal to or higher than a threshold value and present the extracted past texts to the user. It is considered that a set of the reviews set having the influence degrees equal to or higher than the threshold value (that is, a set of reviews having high influence degrees) is a useful review set for the user making a purchase decision. Therefore, the set of reviews having influence degrees equal to or higher than the threshold value may be presented to the user.

The set of reviews having the influence degrees equal to or higher than the threshold value and having ratings equal to or higher than a threshold value (that is, a set of reviews having high influence degrees and high ratings) may be extracted. This prevents the user from giving an unreasonably low rating.

The set of reviews having the influence degree influence degrees equal to or higher than the threshold value and having ratings less than the threshold value (that is, a set of review having high influence degrees and low ratings) may be extracted. This prevents the user from giving an unreasonably high rating.

Each of the reviews included in the set of reviews for each item is associated with the influence degree on the user who has a history of posting the review, and an average thereof may be used as an average influence degree of the set of reviews.

In this case, for a user who has a purchase history but posts no review, the reviews having the average influence degrees equal to or higher than the threshold value (that is, reviews having high average influence degrees) may be used as a query. For a user who does not have a purchase history or post review, the reviews having the average influence degrees equal to or higher than the threshold value may be used as a query.

### Second Exemplary Embodiment

In the first exemplary embodiment, descriptions have been made on the case in which the influence of the past reviews for the item are reflected in the rating. In the present exemplary embodiment, descriptions will be made on a case in which influence of past and future reviews for an item is reflected in a rating.

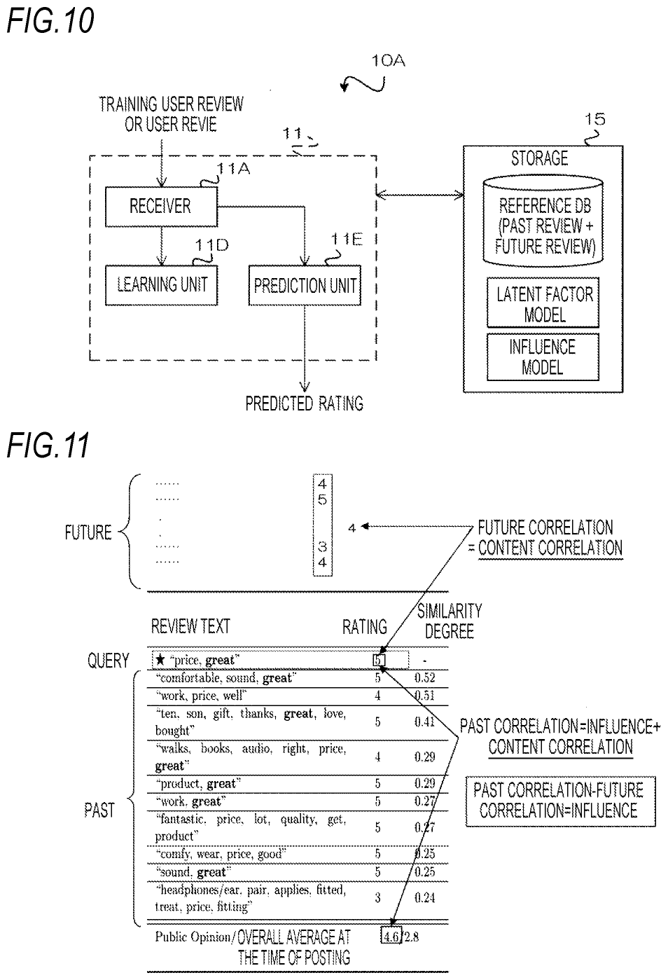

FIG. 10 is a block diagram illustrating an example of a functional configuration of the information processing apparatus 10A according to a second exemplary embodiment. In the information processing apparatus 10A according to the present exemplary embodiment, the same elements as those of the information processing apparatus 10 described in the first exemplary embodiment are designated by the same reference numerals, and the repeated descriptions thereof will be omitted.

As illustrated in FIG. 10, the CPU 11 of the information processing apparatus 10A according to the present exemplary embodiment serves as the receiver 11A, a learning unit 11D, and a prediction unit 11E by writing the information processing program 15A stored in the storage 15 into the RAM 13 and executing the information processing program 15A. In the present exemplary embodiment, the case in which the learning unit 11D and the prediction unit 11E are implemented by a single device is represented. It is noted that as described above, the learning unit 11D and the prediction unit 11E may be implemented by separate devices.

The learning unit 11D according to the present exemplary embodiment trains the latent factor model and the influence model by using the training user reviews and the reference DB. The learning process (training process) by the learning unit 11D is referred to as a “rating learning process”.

When a rating is predicted using the latent factor model and the influence model learned by the learning unit 11D, the receiver 11A according to the present exemplary embodiment receives an input of a user review which is a review for an item from the user. Similar to the training user reviews, the user review includes a purchaser ID, a product ID, and a review text for each review.

Similar to the first exemplary embodiment, the prediction unit 11E according to the present exemplary embodiment uses the reference DB to calculate similarity degrees between the received user review and past reviews for the item that are in the past at the time when the user review is posted. Then, the prediction unit 11E specifies past reviews similar to the user review based on the calculated similarity degrees. Further, the prediction unit 11E uses the reference DB to calculate second similarity degrees between the received user review and future reviews for the item that are in the future at the time when the user review is posted. Then, the prediction unit 11E specifies future reviews similar to the user review based on the calculated second similarity degrees. Then, the prediction unit 11E predicts the user's rating for the item based on ratings associated with the specified past review and future review, respectively. The prediction process by the prediction unit 11E is referred to as a “rating prediction process”.

FIG. 11 is a diagram illustrating a correlation between the content of the review text and the rating, according to the second exemplary embodiment.

The example of FIG. 11 represents a case in which similar reviews are extracted using a review text including the words “price” and “great” as a query.

In the example of FIG. 11, review texts including the word “great” indicated in bold are extracted from the past reviews. In this case, it is seen that there is a correlation between the rating “5” given by the user who writes the review text of the query and an average “4.6” of the extracted ratings. However, this correlation is not caused by the influence, but is due to a strong tendency that a rating given to a review text including the word “great” is high.

To the contrary, the review text of the query is not affected by future reviews. The correlation extracted by performing the same process for the future review as that for the past review is caused by a correlation between the content of the review text and the rating.

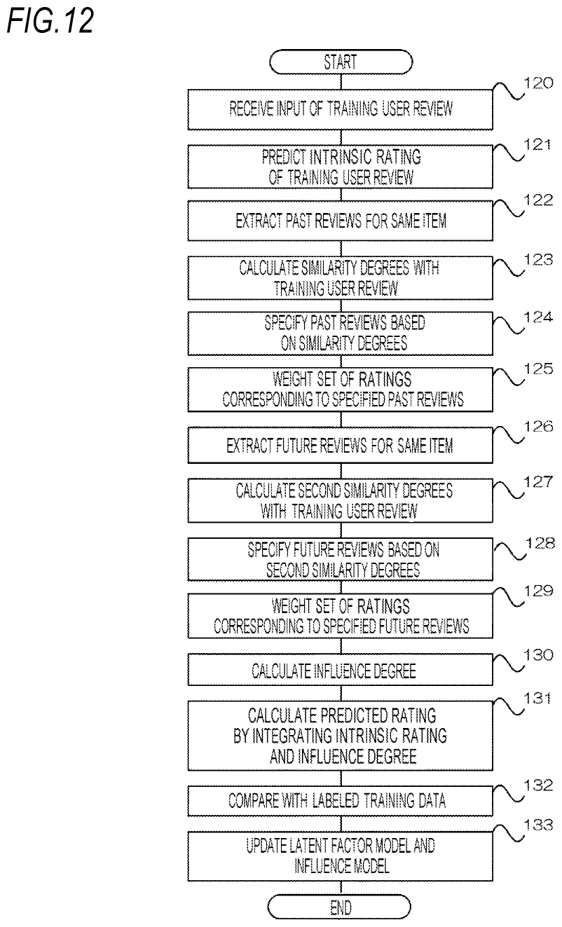

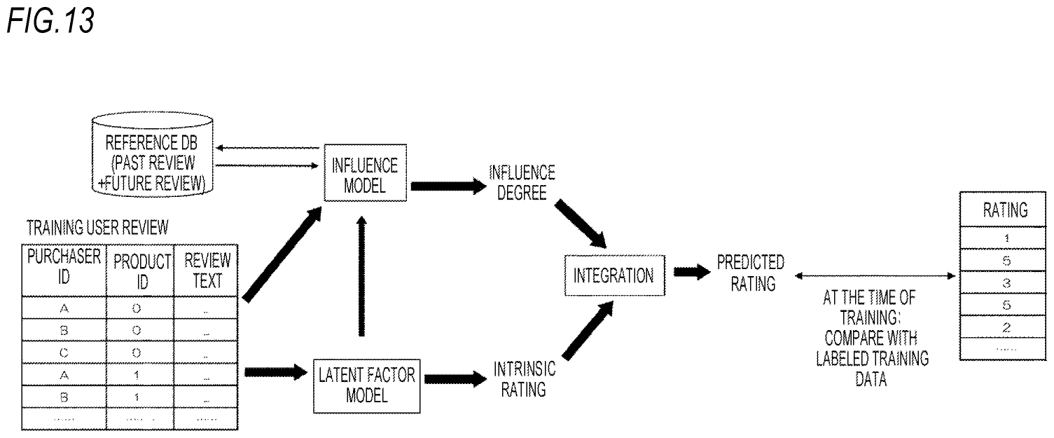

Next, the rating learning process according to the second exemplary embodiment will be specifically described with reference to FIGS. 12 and 13.

FIG. 12 is a flowchart illustrating an example of the rating learning process by the information processing program 15A according to the second exemplary embodiment. FIG. 13 is a diagram illustrating the rating learning process according to the second exemplary embodiment.

First, when the information processing apparatus 10A is instructed to execute the rating learning process, the CPU 11 starts the information processing program 15A and executes each of the following steps.

In step 120 of FIG. 12, the CPU 11 receives an input of training user reviews illustrated in FIG. 13 as an example. As described above, the training user reviews are a set of reviews posted in the past. Each training user review includes a purchaser ID, a product ID, and a review text.

In step 121, the CPU 11 predicts intrinsic ratings, which are potential ratings, by using, for example, a latent factor model illustrated in FIG. 13 for the training user reviews received in step 120. Specifically, the intrinsic ratings are calculated using the above equation (1).

In step 122, the CPU 11 searches, for example, the reference DB illustrated in FIG. 13 based on the training user reviews received in step 120, and extracts past reviews for the same item from the reference DB. The past reviews are reviews that are in the past at the posting date and time of the training user reviews. The past reviews include a set of review texts and a set of ratings, for each same item.

In step 123, the CPU 11 calculates similarity degrees between the training user reviews and each of the past reviews extracted in step 122. For the calculation of the similarity degrees, known methods such as, for example, the LDA or the TF-IDF may be used.

In step 124, the CPU 11 specifies past reviews based on the similarity degrees calculated in step 123. The specified past reviews may be a predetermined part of the past reviews that are arranged in descending order of the similarity degrees, or may be all past reviews for which the similarity degrees are calculated.

In step 125, the CPU 11 uses, for example, the influence model illustrated in FIG. 13 to calculate a weighted average value of the set of ratings corresponding to the past reviews specified in step 124 using the similarity degrees as weighting values. The set of ratings is represented, for example, as a set containing a predetermined number of ratings ranked by the similarity degrees.

The weighting of the ratings may be performed using an order in which the past reviews are actually displayed on a predetermined EC site (see, for example, FIG. 2) in addition to the similarity degrees. The weighting of the ratings may be performed using a statistic including at least one of a variance, a median value, or a mode value of the ratings that are obtained from the set of ratings.

In step 126, the CPU 11 searches, for example, the reference DB illustrated in FIG. 13 based on the training user reviews received in step 120, and extracts future reviews for the same item from the reference DB. The future reviews are reviews that are in the future at the posting date and time of the training user reviews. The future reviews include a set of review texts and a set of ratings, for each same item.

In step 127, the CPU 11 calculates second similarity degrees between the training user reviews and each of the future reviews extracted in step 126. As described above, for the calculation of the second similarity degrees, for example, known methods such as LDA or TF-IDF may be used.

In step 128, the CPU 11 specifies future reviews based on the second similarity degrees calculated in step 127. The specified future reviews may be a predetermined part of the future reviews that are arranged in descending order of the second similarity degrees, or may be all the future reviews for which the second similarity degrees are calculated.

In step 129, the CPU 11 uses, for example, the influence model illustrated in FIG. 13 to calculate a second weighted average value that is a weighted average value of the set of ratings corresponding to the future reviews specified in step 128 using the second similarity degrees as weighting values. The set of ratings is represented, for example, as a set containing a predetermined number of ratings ranked by the second similarity degrees.

The weighting of the ratings may be performed using an order in which the future reviews are actually displayed on a predetermined EC site (see, for example, FIG. 2) in addition to the second similarity degrees. The weighting of the ratings may be performed using a statistic including at least one of a variance, a median value, or a mode value of the ratings that are obtained from the set of ratings.

In step 130, the CPU 11 calculates an influence degree indicating a degree of influence received from the past reviews and the future reviews. The influence degree (=r_{EK}) is expressed as a difference between (i) a difference between (a) the weighted average value (=r_{infl 1}) calculated in step 125 and (b) the second weighted average value (=r_{infl2}) calculated in step 129, and (ii) the intrinsic rating (=r_{LF}) predicted in step 121. Specifically, the influence degree r_{EK} is expressed by the following equation (4).

r_{EK}=r_{infl 1}−r_{infl2}−r_{LF} (4)

In step 131, the CPU 11 calculates predicted ratings by integrating the intrinsic ratings predicted in step 121 and the influence degrees calculated in step 130, as illustrated in, for example, FIG. 13. Specifically, the predicted rating is calculated using the above equation (3).

In step 132, the CPU 11 compares the predicted ratings calculated in step 131 with labeled training data of the ratings associated with the training user reviews, as illustrated in, for example, FIG. 13.

In step 133, the CPU 11 updates the latent factor model and the influence model such that the prediction result of the rating approaches the labeled training data based on the comparison result in step 132, and ends the rating learning process by the information processing program 15A.

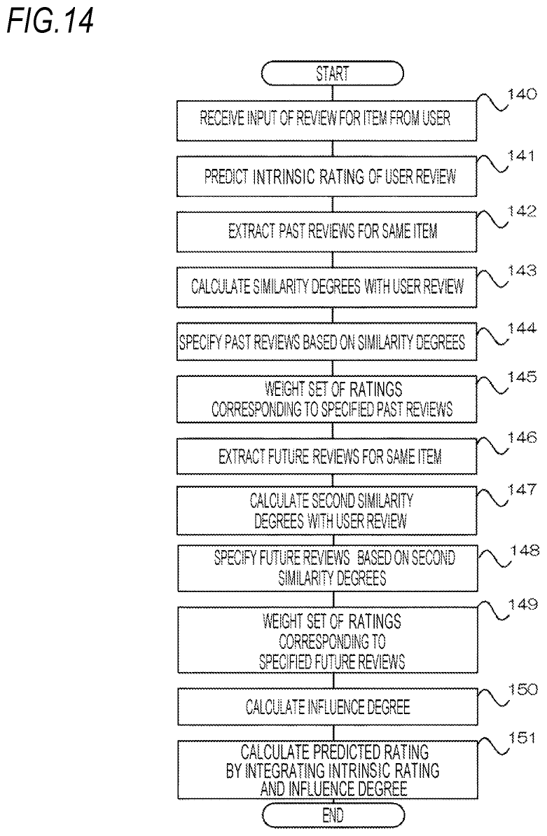

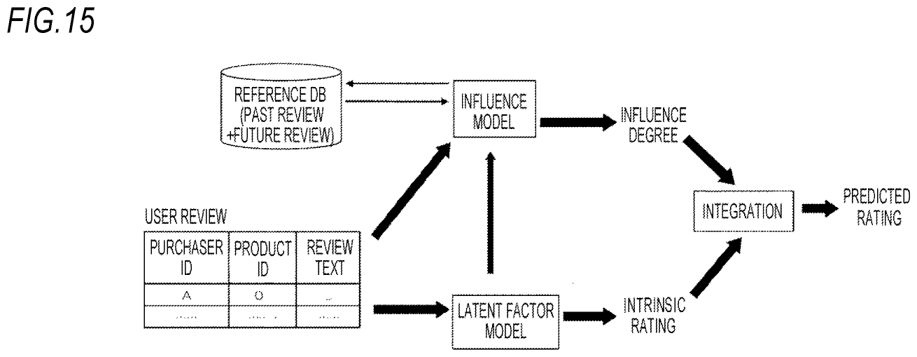

Next, the rating prediction process according to the second exemplary embodiment will be specifically described with reference to FIGS. 14 and 15. In this rating prediction process, the latent factor model and the influence model trained in the rating learning process are used.

FIG. 14 is a flowchart illustrating an example of the rating prediction process by the information processing program 15A according to the second exemplary embodiment. FIG. 15 is a diagram illustrating the rating prediction process according to the second exemplary embodiment.

First, when the information processing apparatus 10A is instructed to execute the rating prediction process, the CPU 11 starts the information processing program 15A and executes each of the following steps.

In step 140 of FIG. 14, the CPU 11 receives an input of a user review as illustrated in, for example, FIG. 15. This user review includes a purchaser ID, a product ID, and a review text for each review.

In step 141, the CPU 11 predicts an intrinsic rating, which is a potential rating, by using, for example, the latent factor model illustrated in FIG. 15 for the user review received in step 140. Specifically, the intrinsic rating is calculated by the above equation (1).

In step 142, the CPU 11 searches, for example, the reference DB illustrated in FIG. 15 based on the user review received in step 140, and extracts past reviews for the same item from the reference DB. The past reviews include reviews that are in the past at the posting date and time of the user review. The past reviews include a set of review texts and a set of ratings, for each same item.

In step 143, the CPU 11 calculates a similarity degree between the user review and each of the past reviews extracted in step 142. For the calculation of the similarity degrees, known methods such as, for example, the LDA or the TF-IDF may be used.

In step 144, the CPU 11 specifies past reviews based on the similarity degrees calculated in step 143. The specified past reviews may be a predetermined part of the past reviews that are arranged in descending order of the similarity degrees, or may be all past reviews for which the similarity degrees are calculated.

In step 145, the CPU 11 uses, for example, the influence model illustrated in FIG. 15 to calculate a weighted average value of the set of ratings corresponding to the past reviews specified in step 144 using the similarity degrees as weighting values. As described above, the set of ratings is represented as a set containing a predetermined number of ratings ranked by the similarity degrees.

As described above, the weighting of the ratings may be performed using an order in which the past reviews are actually displayed on a predetermined EC site (see, for example, FIG. 2) in addition to the similarity degrees. The weighting of the ratings may be performed using a statistic including at least one of a variance, a median value, or a mode value of the ratings that are obtained from the set of ratings.

In step 146, the CPU 11 searches, for example, the reference DB illustrated in FIG. 15 based on the user review received in step 140, and extracts future reviews for the same item from the reference DB. The future reviews are reviews that are in the future at the posting date and time of the user review. The future reviews include a set of review texts and a set of ratings, for each same item.

In step 147, the CPU 11 calculates a second similarity degree between the user review and each of the future reviews extracted in step 146. For the calculation of this second similarity degrees, for example, known methods such as the LDA or the TF -IDF may be used.

In step 148, the CPU 11 specifies future reviews based on the second similarity degrees calculated in step 147. The specified future reviews may be a predetermined part of the future reviews that are arranged in descending order of the second similarity degrees, or may be all the future reviews for which the second similarity degrees are calculated.

In step 149, the CPU 11 uses, for example, the influence model illustrated in FIG. 15 to calculate a second weighted average value that is a weighted average value of the set of ratings corresponding to the future reviews specified in step 148 using the second similarity degrees as weighting values. As described above, the set of ratings is represented as a set including a predetermined number of ratings ranked by the second similarity degrees.

As described above, the weighting of the ratings may be performed using an order in which the future reviews are actually displayed on the predetermined EC site (see FIG. 2) in addition to the second similarity degrees. The weighting of the ratings may be performed using a statistic including at least one of a variance, a median value, or a mode value of the ratings that are obtained from the set of ratings.

In step 150, the CPU 11 calculates an influence degree indicating a degree of influence received from the past reviews and the future reviews. This influence degree is expressed as a difference between (i) a difference between (a) the weighted average value calculated in step 145 and (b) the second weighted average value calculated in step 149 and (ii) the intrinsic rating predicted in step 141. Specifically, the influence degree is expressed using the above equation (4).

In step 151, for example, as illustrated in FIG. 15, the CPU 11 integrates the intrinsic rating predicted in step 151 and the influence degree calculated in step 150 to calculate the predicted rating, and ends the rating prediction process by the information processing program 15A. Specifically, the predicted rating is calculated using the above equation (3).

As described above, according to the present exemplary embodiment, since the influence of the past and future reviews on the item is reflected, the user's subjective rating for the item is predicted more accurately.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The information processing apparatus according to the exemplary embodiment has been described above. The exemplary embodiment may be a form of a program for causing a computer to execute the function of each unit included in the information processing apparatus. The exemplary embodiment may be in the form of a non-temporary storage medium that may be read by a computer that stores these programs.

In addition, the configuration of the information processing apparatus described in the above exemplary embodiment is an example, and may be changed depending on the situation within a range that does not deviate from the gist of the present disclosure.

Further, the processing flow of the program described in the above exemplary embodiment is also an example, and unnecessary steps may be deleted, new steps may be added, or the processing order may be changed within a range that does not deviate from the gist of the present disclosure.

In the above-described exemplary embodiment, descriptions have been made on the case where the process according to the exemplary embodiment is implemented by the software configuration by using the computer by executing the program, but the present disclosure is not limited thereto. The exemplary embodiments may be implemented by, for example, a hardware configuration or a combination of a hardware configuration and a software configuration.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus comprising:
a processor configured to:
receive a text for a target that is input from a user;
specify past texts similar to the received text based on similarity degrees between the received text and past texts that are in the past at a time when the text for the target is posted; and
predict a user's rating for the target based on ratings associated with the specified past texts.

2. The information processing apparatus according to claim 1, wherein
the processor is configured to:
predict an intrinsic rating that is a potential rating obtained from the received text;
predict an influence degree indicating a degree of an influence received from the past texts; and
predict the user's rating for the target by integrating the influence degree and the intrinsic rating.

3. The information processing apparatus according to claim 2, wherein
the influence degree is expressed as a difference between (i) a value obtained by calculating a weighted average value of a set of ratings corresponding to the specified past texts using the similarity degrees as weighting values and (ii) the intrinsic rating.

4. The information processing apparatus according to claim 3, wherein the set of the ratings is a set containing a predetermined number of ratings ranked by the similarity degrees.

5. The information processing apparatus according to claim 3, wherein the weighting is performed using an order in which the past texts are displayed on a predetermined electronic commerce site in addition to the similarity degrees.

6. The information processing apparatus according to claim 4, wherein the weighting is performed using an order in which the past texts are displayed on a predetermined electronic commerce site in addition to the similarity degrees.

7. The information processing apparatus according to claim 3, wherein
the weighting is performed using a statistic including at least one of a variance, a median, or a mode of the ratings that are obtained from the set of ratings.

8. The information processing apparatus according to claim 4, wherein
the weighting is performed using a statistic including at least one of a variance, a median, or a mode of the ratings that are obtained from the set of ratings.

9. The information processing apparatus according to claim 5, wherein
the weighting is performed using a statistic including at least one of a variance, a median, or a mode of the ratings that are obtained from the set of ratings.

10. The information processing apparatus according to claim 6, wherein
the weighting is performed using a statistic including at least one of a variance, a median, or a mode of the ratings that are obtained from the set of ratings.

11. The information processing apparatus according to claim 2, wherein
the processor is configured to predict the intrinsic rating by calculating an inner product of an item representation representing the target and a user representation representing the user that are projected on a same latent space, using a latent factor model obtained by machine learning.

12. The information processing apparatus according to claim 3, wherein
the processor is configured to predict the intrinsic rating by calculating an inner product of an item representation representing the target and a user representation representing the user that are projected on a same latent space, using a latent factor model obtained by machine learning.

13. The information processing apparatus according to claim 2, wherein
the processor is configured to integrate the influence degree and the intrinsic rating by adding the intrinsic rating to a product of a coefficient learned uniquely for each user and the influence degree.

14. The information processing apparatus according to claim 1, wherein
the processor is configured to:
further specify future texts similar to the received text based on second similarity degrees between the received text and future texts for the target at the time when the text for the target is posted; and
predict the user's rating for the target based on ratings that are associated with the specified past texts and the specified future texts, respectively.

15. The information processing apparatus according to claim 14, wherein
processor is configured to:
predict an intrinsic rating that is a potential rating obtained from the received text;
predict influence degrees indicating degrees of influence received from the past texts and the future texts; and
predict the user's rating for the target by integrating the influence degrees and the intrinsic rating.

16. The information processing apparatus according to claim 15, wherein
the influence degree is expressed as a difference between (i) a difference between (a) a value obtained by calculating a weight average value of a set of the ratings corresponding to the specified past texts using the similarity degrees as weighting values and (b) a value obtained by calculating a weighted average value of a set of the ratings corresponding to the specified future texts using the second similarity degrees as weighting values and (ii) the intrinsic rating.

17. The information processing apparatus according to claim 1, wherein
the processor is configured to perform control so as to present the predicted rating to the user when the user is to input a rating associated with the text that the user inputs for the target.

18. The information processing apparatus according to claim 1, wherein
the processor is configured to, when a rating that is input in association with the text that the user inputs for the target is different from the predicted rating, perform control so as to present to the user a fact that the input rating is different from the predicted rating.

19. The information processing apparatus according to claim 2, wherein
the processor is configured to:
perform control so as to extract the past texts having the influence degrees equal to or higher than a threshold value, and
present the extracted past texts to the user.

20. A non-transitory computer readable medium storing a program that causes a computer to execute information processing, the information processing comprising:
receiving a text for a target that is input from a user;
specifying past texts similar to the received text based on similarity degrees between the received text and past texts that are in the past at a time when the text for the target is posted; and
predicting a user's rating for the target based on ratings associated with the specified past texts.
